(19) United States
(12) Patent Application Publication
(10) Pub. No.: US 2015/0058922 A1
(43) Pub. Date: Feb. 26, 2015

(54) METHOD AND APPARATUS FOR CONTROLLING NETWORK DEVICE

(71) Applicant: Huawei Technologies Co., Ltd., Shenzhen (CN)

(72) Inventors: Yinben Xia, Shenzhen (CN); Fengkai Li, Shenzhen (CN)

(21) Appl. No.: 14/530,040

(22) Filed: Oct. 31, 2014

Related U.S. Application Data
(63) Continuation of application No. PCT/CN2012/074963, filed on May 2, 2012.

(51) Int. Cl. H04L 29/06

(52) U.S. Cl. CPC H04L 63/0227; H04L 63/08; H04L 63/10
USPC 726/1

(57) ABSTRACT

The present invention relates to the field of communications and discloses a method and an apparatus for controlling a network device. An open service platform intercepts an instruction packet sent to a network device, identifies authority of the instruction packet and judges whether the instruction packet is in conflict with a previous instruction, and sends the instruction packet to the network device if the instruction packet has the authority and is not in conflict with the previous instruction. The method and apparatus can ensure correct and lawful control caused by the instruction packet on the network device.

### CROSS-REFERENCE TO RELATED APPLICATIONS

This application is a continuation of International Application No. PCT/CN2012/074963, filed on May 2, 2012, which is hereby incorporated by reference in its entirety.

### TECHNICAL FIELD

The present invention relates to the field of communication and, in particular, to a method and an apparatus for controlling a network device.

### BACKGROUND

With the continuous development of network technologies, network bandwidth traffic becomes heavier and heavier; however, profit per bit gets lower and lower, and operators are gradually turning into pipe providers. It is an urgent need for the operators to have the capacity of sharing profits with the Internet content provider (full name in English: Internet Content Provider, ICP for short) and the Internet service provider (full name in English: Internet Service Provider, ISP for short); and refined operation on network is one of approaches for the operators to improve the capacity of realizing profit sharing.

Generally, many services may be deployed on an open service platform corresponding to one network device simultaneously, the existing open service platform only analyzes and counts the services, but does not make any judgment or modification to data and control instructions, There may exist malicious services and services with imperfect logic. These services may conduct error control on the network device, thereby causing disastrous consequences on the network device.

### SUMMARY

Accordingly, embodiments of the present invention provide a method and an apparatus for controlling a network device, which can be applied to open network device architecture.

In one aspect, embodiments of the present invention provide a method for controlling a network device, including: intercepting, by an open service platform, a first control instruction packet sent to a network device and judging, by the open service platform, whether control caused by the first control instruction packet on the network device meets a predefined rule; if the control does not meet the predefined rule, preventing, by the open service platform, the first control instruction packet from being sent to the network device.

In another aspect, embodiments of the present invention provide an apparatus for controlling an network device, the apparatus includes an authentication conflict control module and a data storage unit; the data storage unit is configured to store an intercepted first control instruction packet sent to a network device and a predefined rule; the authentication conflict control module is configured to read the first control instruction packet and the predefined rule from the data storage unit, and judge whether control caused by the first control instruction packet on the network device meets the predefined rule according to the predefined rule; and the authentication conflict control module prevents the first control instruction packet from being sent to the network device if the control caused by the first control instruction packet on the network device does not meet the predefined rule.

According to the technical solutions of embodiments of the present invention, the following technical effects can be achieved: accuracy of service processing and control can be ensured, and error control caused by malicious services and services with imperfect logic on the network device can be prevented. Therefore, the accuracy and validity of the control caused by an open service system on the network device are ensured so that the network device is robust and secure.

### BRIEF DESCRIPTION OF DRAWINGS

FIG. 1 is a flow chart of a method according to an embodiment of the present invention;

FIG. 2a is a sub-flow chart of a method according to an embodiment of the present invention;

FIG. 2b is a sub-flow chart of a method according to an embodiment of the present invention;

FIG. 3a is a sub-flow chart of a method according to an embodiment of the present invention;

FIG. 3b is a sub-flow chart of a method according to an embodiment of the present invention;

FIG. 4 is a schematic networking diagram according to an embodiment of the present invention;

FIG. 5a is schematic diagram of a configuration file according to an embodiment of the present invention;

FIG. 5b is schematic diagram of a configuration file according to an embodiment of the present invention;

FIG. 6 is a schematic diagram of a system according to an embodiment of the present invention;

FIG. 7 is a schematic diagram of an apparatus according to an embodiment of the present invention; and

FIG. 8 is a schematic diagram of modules according to an embodiment of the present invention.

### DESCRIPTION OF EMBODIMENTS

To describe the objectives, technical solutions and merits of embodiments of the present invention more clearly, the following further describes the present invention with reference to the accompanying drawings and embodiments. It should be understood that the specific embodiments described here are only to illustrate the present invention, and are not intended to limit the present invention. Embodiments of the present invention include a method and an apparatus for controlling a network device. The method included in embodiments of the present invention may be implemented by a hardware device such as a general computer or a network server.

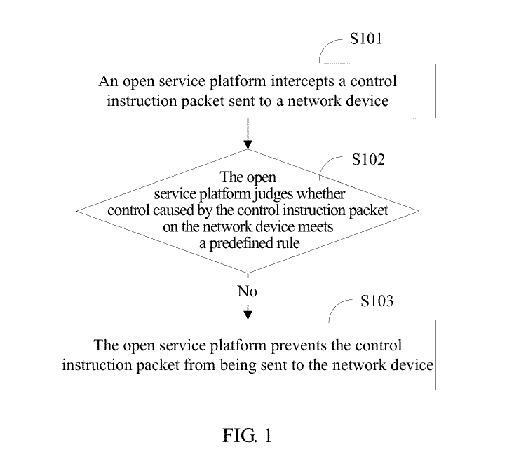

According to an embodiment of the present invention, as shown in FIG. 1, a method for controlling a network device includes: S101, an open service platform intercepts a first control instruction packet sent to a network device; S102, the open service platform judges whether control caused by the first control instruction packet on the network device meets a predefined rule; and S103, if the control does not meet the predefined rule, the open service platform prevents the first control instruction packet from being sent to the network device.

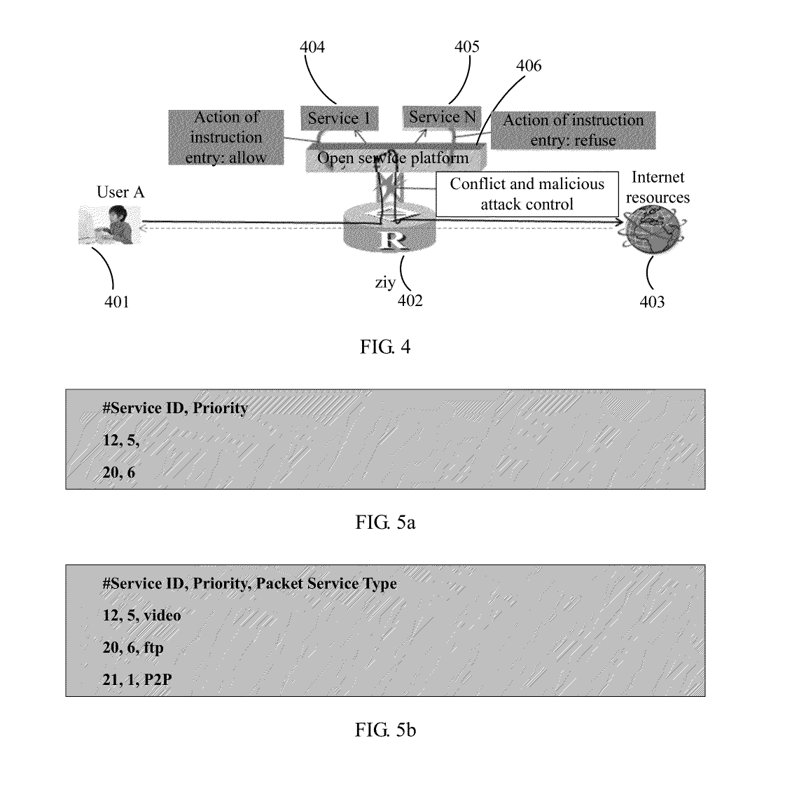

FIG. 4 shows an application scenario of the present invention, where a user A (401) accesses internet resources 403 through an internet (internet) device. Various requests of the user A arrive at a network device, an example of the network device is a router 402 shown in the lower part of FIG. 4. Requests of a user are sent to an open service platform 406. The various requests may be voice, video streaming downloading, accessing the internet and even attacking Internet servers maliciously. The open service platform 406 identifies and classifies the requests of the user, for example, voice enhancement services, video enhancement services, bandwidth control services, and the like. A device for implementing the above functions of the open service platform 406 is an apparatus for controlling a network device disclosed in the present invention. The apparatus implements the controlling method disclosed in the present invention, thus control instructions not meeting the predefined rule can be filtered.

Optionally, according to an embodiment of the present invention, the judging whether control caused by the first control instruction packet on the network device meets the predefined rule may be: judging whether the control caused by the first control instruction packet on the network device has authorization.

Further, optionally, according to an embodiment of the present invention, the judging whether control caused by the first control instruction packet on the network device meets the predefined rule may include:

acquiring a service identifier (ID) corresponding to the first control instruction packet;

judging whether a service corresponding to the first control instruction packet has authorization by utilizing an authorized service ID list; and

determining that the control caused by the first control instruction packet on the network device does not meet the predefined rule if the service corresponding to the first control instruction packet does not have the authorization.

Optionally, according to an embodiment of the present invention, the judging whether control caused by the first control instruction packet on the network device meets the predefined rule may be: judging whether the control caused by the first control instruction packet on the network device is in conflict with control caused by a control instruction packet intercepted by the open service platform prior to the first control instruction packet on the network device.

For convenience of expression, the control instruction packet is called a first control instruction packet, and a control instruction packet intercepted by the open service platform prior to the control instruction packet is called a second control instruction packet.

Further, optionally, according to an embodiment of the present invention, priority of the first control instruction packet is compared with priority of the second control instruction packet if the control caused by the first control instruction packet on the network device is in conflict with the control caused by the second control instruction packet on the network device.

If the priority of the first control instruction packet is lower than the priority of the second control instruction packet, it is determined that control caused by the control instruction packet on the network device does not meet the predefined rule.

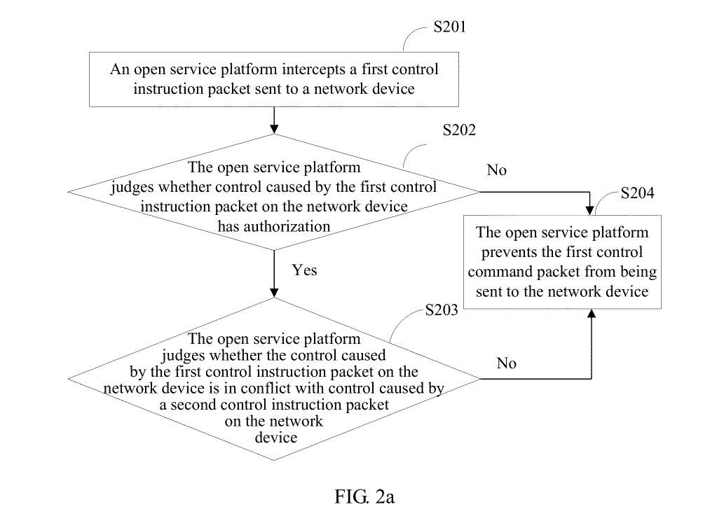

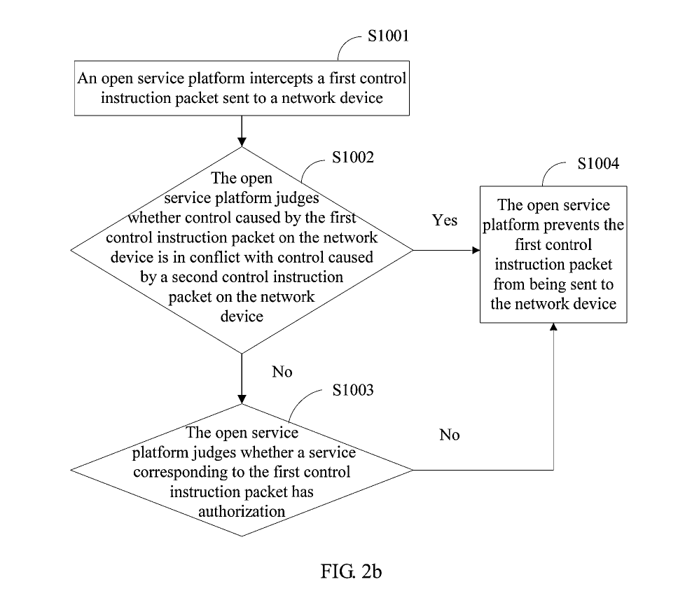

Optionally, according to an embodiment of the present invention, as shown in FIG. 2a, in S201, the first control instruction packet sent to the network device is intercepted. In S202, it is judged whether the control caused by the first control instruction packet on the network device has authorization. If the control does not have the authorization, the process goes to S204 for preventing the first control instruction packet from being sent to the network device; and if the control has the authorization, the process goes to S203 for further judging whether the control caused by the first control instruction packet on the network device is in conflict with the control caused by the second control instruction packet on the network device. If the control caused by the first control instruction packet on the network device is in conflict with the control caused by the second control instruction packet on the network device, the process goes to S204 for preventing the first control instruction packet from being sent to the network device.

Optionally, according to an embodiment of the present invention, as shown in FIG. 2b, in S1001, the first control instruction packet sent to the network device is intercepted. In S1002, it is judged whether the control caused by the first control instruction packet on the network device is in conflict with the control caused by the second control instruction packet on the network device. If the control caused by the first control instruction packet is in conflict with the control caused by the second control instruction packet, the process goes to S1004 for preventing the first control instruction packet from being sent to the network device. If the control caused by the first control instruction packet is not in conflict with the control caused by the second control instruction packet, the process goes to S1003. In S1003, it is judged whether the service corresponding to the first control instruction packet has authorization. If the service does not have the authorization, the process goes to S1004 for preventing the first control instruction packet from being sent to the network device.

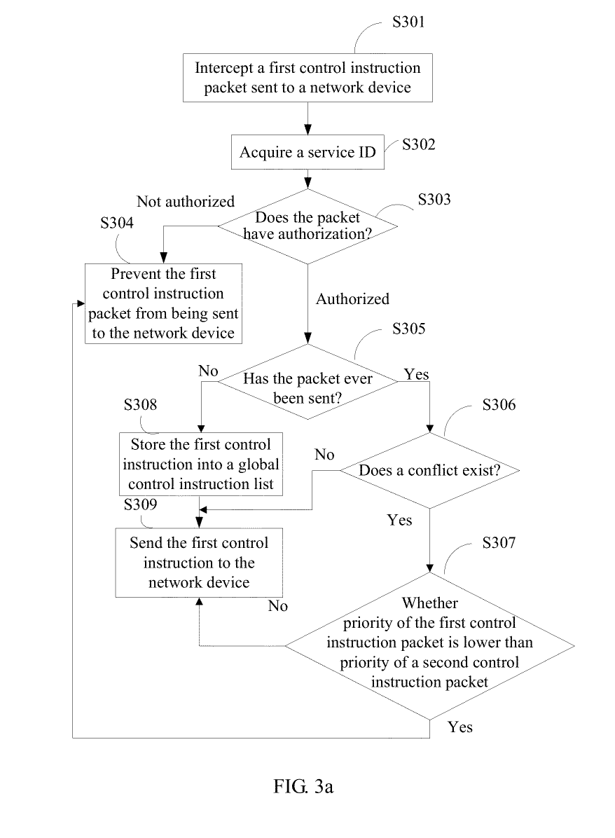

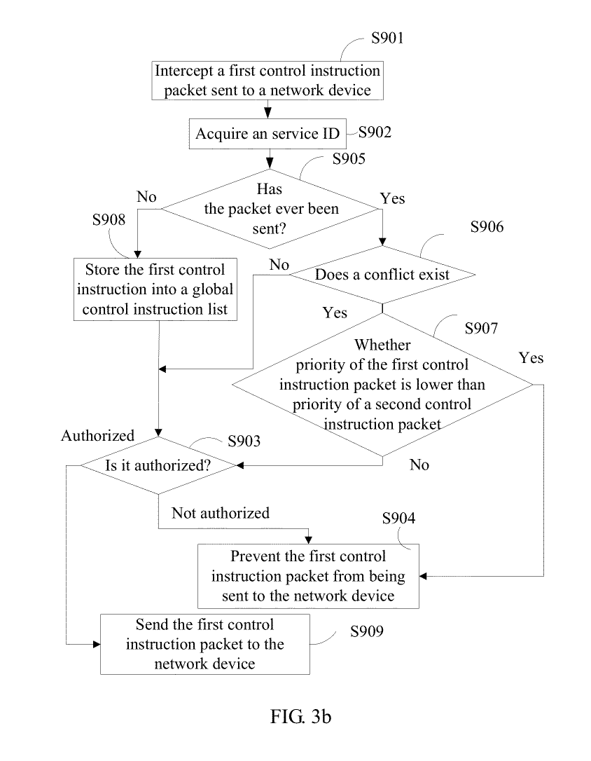

According to an embodiment of the present invention, as shown in FIG. 3a, in S301, the first control instruction packet sent to the network device is intercepted. In S302, a service identifier ID corresponding to the first control instruction packet is acquired. The service ID is a serial number for the open service platform to deploy a service and is mainly used for identifying the service. The service ID may be an incremental number, such as 1, 2, 3, 4, 5 . . . For example, service 1 is a video enhancement service, service 2 is a voice enhancement service, and service 3 is a green internet service. Authorization of the services 1, 2 and 3 may be as follows: service 1 allows control on video packets; service 2 allows control on voice packets; and service 3 allows control on Hypertext Transfer Protocol http (Hypertext Transfer Protocol) packets, and the like. In S303, it is judged whether the service corresponding to the first control instruction packet has authorization according to the ID list of authorized services.

According to an embodiment of the present invention, the ID list of authorized services may be represented as a service authority configuration file. Therefore, in S303, the service authority configuration file may be utilized to judge whether the service corresponding to the first control instruction packet has the authorization. As shown in FIG. 5a, the service authority configuration file may include the service ID and priority. The service ID is unique on the open service platform and is a unique identifier of a service. Only when the service ID is in the service authority configuration file, a control instruction of the service can be sent to the network device through the open service platform. If the service ID is not in the service authority configuration file, the service is not authorized to send down a network device control instruction. The priority is used for representing an authority level for controlling the network device of the service, and the priority is an integer; preferably, the smaller the value is, the higher the priority is.

Optionally, the service authority configuration file can be set to be more complex. For example, packet service type can be added so as to indicate which service types of data packets can be processed by the service and send control instructions to the network device in regard to services. As shown in FIG. 5b, a packet service type corresponding to a service with a service ID of 12 is video and authorization of the service with a service ID of 12 is to control video; if a control instruction sent by the service with a service ID of 12 to the network device is to control uploading of ftp (File Transfer Protocol) data packets, the control instruction is considered as an unauthorized control instruction. Likewise, an authorized authority of a service with a service ID of 20 is to control ftp data packets; if a control instruction sent by the service with a service ID of 20 to the network device is to control point-to-point P2P data packets, the control instruction is considered as an unauthorized control instruction.

The authorized service ID list includes authorized authorities corresponding to each service; for example, the authorized authority of the service with a service ID of 20 is to control the ftp data packets.

If the judging result in S303 is that the service corresponding to the first control instruction packet does not have the authorization, in S304, the first control instruction packet is prevented from being sent to the network device. Optionally, error information is sent to a sender of the first control instruction packet after the first control instruction packet is prevented from being sent to the network device.

If the judging result in S303 is that the service corresponding to the first control instruction packet has the authorization, in S305, a global control instruction list is traversed to judge whether the first control instruction packet has ever been sent, where the global control instruction list is a list including sent control instruction packets. If the judging result in S305 is that the first control instruction packet has not been sent, in S308, the first control instruction packet is stored into the global control instruction list. In S309, the first control instruction packet is sent to the network device. In S310, the sub-process ends.

If the judging result in S305 is that the first control instruction packet has ever been sent, in S306, it is judged whether the control caused by the first control instruction packet on the network device is in conflict with the control caused by the second control instruction packet on the network device. For example, for a data packet of a video watched online, if the first control instruction packet is an instruction for ensuring bandwidth whereas the second control instruction packet is an instruction for preventing watching, a conflict exits between controls caused by the two control instruction packets on the network device. If the judging result in S306 is that the controls are not in conflict with each other, the process goes to S309 for sending the first control instruction packet to the network device. If the judging result in S306 is that the controls are in conflict with each other, in S307, the priority of the first control instruction packet is compared with the priority of the second control instruction packet. If the priority of the first control instruction packet is lower than the priority of the second control instruction packet, the process goes to S304 for preventing the first control instruction packet from being sent to the network device. If the priority of the first control instruction packet is not lower than the priority of the second control instruction packet, the process goes to S309 for sending the first control instruction packet to the network device.

According to another embodiment of the present invention, as shown in FIG. 3b, in S901, the first control instruction packet sent to the network device is intercepted. In S902, a service ID is acquired. In S905, a sent global control instruction list is traversed to judge whether the first control instruction packet has ever been sent. If the first control instruction packet has ever been sent, in S906, it is judged whether the control caused by the first control instruction packet on the network device is in conflict with the control caused by the second control instruction packet on the network device. If the first control instruction packet has not been sent, in S908, the first control instruction packet is stored into the global control instruction list, and the process goes to S903.

If the judging result in S906 is that the controls are in conflict with each other, the process goes to S907 for comparing the priority of the first control instruction packet and the priority of the second control instruction packet. If the priority of the first control instruction packet is lower than the priority of the second control instruction packet, the process goes to S904 for preventing the first control instruction packet from being sent to the network device. If the priority of the first control instruction packet is not lower than the priority of the second control instruction packet, the process goes to S903 for judging whether the first control instruction packet has authorization. If the judging result in S906 is that no conflicts exist between the controls, the process goes to S903.

In S903, it is judged whether the first control instruction packet has the authorization according to a service authority configuration file. If the first control instruction packet does not have the authorization, the process goes to S904 for preventing the first control instruction packet from being sent to the network device. Optionally, error information may be sent to the sender of the first control instruction packet after the first control instruction packet is prevented from being sent to the network device. If the first control instruction packet has the authorization, in S909, the first control instruction packet is sent to the network device.

By adopting the method according to embodiments of the present invention, conflict judgment is performed firstly, and then the authorization judgment is performed, therefore, redundant authorization judgments can be reduced and, thus, the operating process is quickened.

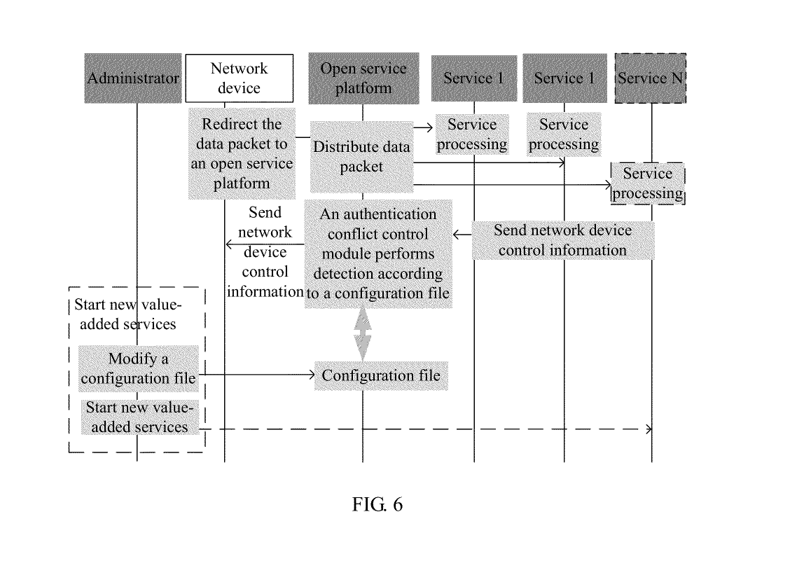

Optionally, the method of the present invention further includes: providing a network interface platform for an administrator of the open service platform. The administrator may change the authorized service ID list such as the service authority configuration file used by the open service platform at any time according to the demand of service deployment. The service authority configuration file may also include the predefined rules applied in S102, so as to make newly-added service configuration file items to meet deployment demands of newly-added services or change priority of deployed service. As shown in FIG. 6, the administrator may start the new-added services and set parameters such as service ID, authority and priority for the new-added services in the configuration file.

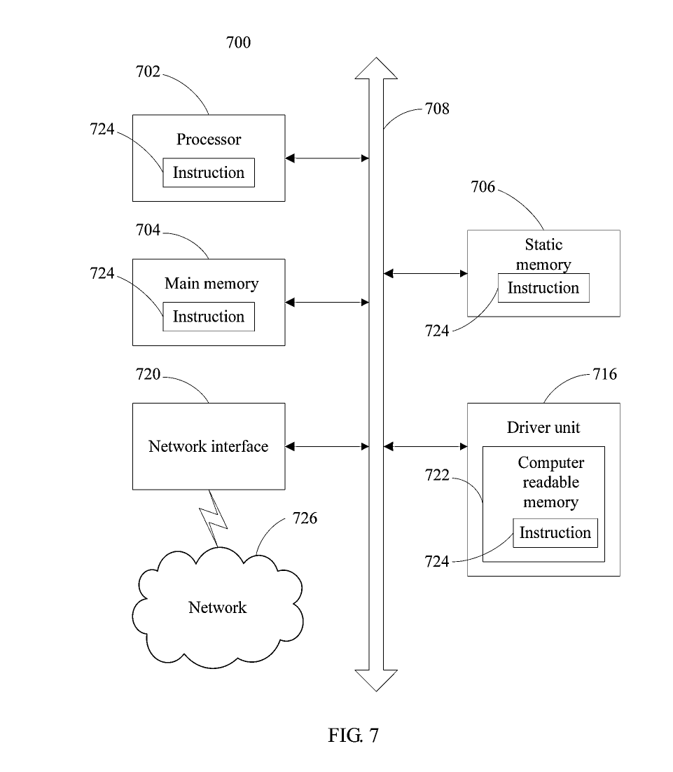

FIG. 7 is a simplified example of an apparatus for implementing the method of the present invention and the apparatus can execute the method of the present invention. Optionally, the apparatus may be connected to other apparatuses through, for example, the network connection. The apparatus may execute a series of instructions in sequence or in parallel. Besides, although only one apparatus is shown in FIG. 7, it should be understand that the “apparatus” can be interpreted as a single apparatus or a set of a plurality of apparatuses for executing the method of the present invention.

The apparatus 700 includes a processor 702 (such as a central processing unit CPU). The processor 702 may execute functions such as calculation, selection or comparison, for example, S303, S305 and S306 included in the method of the present invention. A main memory 704 may store parameters relevant to the method of the present invention, for example, a service authority configuration file and/or a global internal control instruction list, and the like. A static memory 706 may also store parameters relevant to the method of the present invention, for example, a global internal control instruction list, and the like. The processor 702, the main memory 704 and the static memory 706 are communicated by using a bus 708. The apparatus 700 may further include a disc driver unit 710 and a network interface apparatus 712. The disc driver unit 710 may also store parameters relevant to the method of the present invention, for example, a global internal control instruction list, and the like. The network interface device 712 can make the apparatus 700 to be capable of communicating with the outside, for example, intercepting the control instruction packet sent to the network device in step S201 and sending the control instruction to the network device in step S309.

The disc driver unit 710 includes a machine-readable medium 722, where the machine-readable medium 722 stores more than one internal control instructions, and a data structure 724 (for example, a software) for executing the method of the present invention. The internal control instructions may also be partially or completely stored in the main memory 704 or the processor 702. The foregoing machine-readable medium may also include the internal control instructions and the main memory 704. In addition, the internal control instructions may be transmitted to or received from a network side 726 through the network interface device 712 by using existing communication protocols.

The machine-readable medium 722 may include a single medium or multiple mediums (for example, centralized or distributed database or related cache) for storing the instructions. A term “machine-readable medium” may also be understood as any storing, coding or bearing medium of instructions which are carried out by a machine and are capable of implementing the instructions of the method of the present invention. The term “machine-readable medium” may also be understood as including a solid-state memory and an optomagnetic medium.

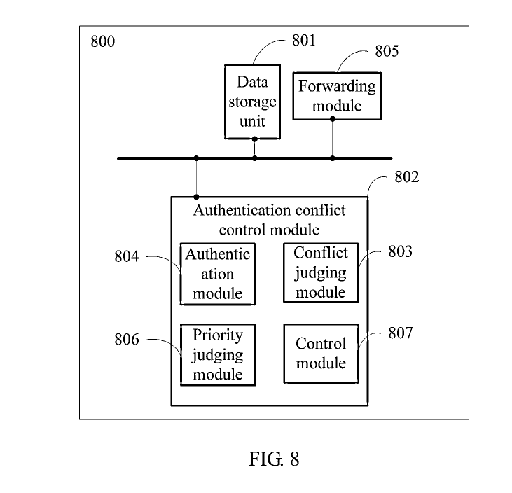

According to an embodiment of the present invention, an apparatus for controlling a network device is shown in FIG. 8. An apparatus 800 includes a data storage unit 801 and an authentication conflict control module 802. The data storage unit 801 is configured to store an intercepted first control instruction packet sent to a network device and a predefined rule. The authentication conflict control module 802 is capable of communicating with the data storage unit 801 and the authentication conflict control module 802 is configured to read the first control instruction packet and the predefined rule from the data storage unit 801, and judge whether control caused by the first control instruction packet on the network device meets the predefined rule according to the predefined rule. If the control caused by the first control instruction packet does not meet the predefined rule, the authentication conflict control module 802 prevents the first control instruction packet from being sent to the network device.

Optionally, the authentication conflict control module 802 may further include an authentication module 804, a conflict judging module 803, a priority judging module 806 and a control module 807. The authentication module 804 is configured to judge whether the control caused by the first control instruction packet on the network device has authorization. The conflict judging module 803 is configured to judge whether the control caused by the first control instruction packet on the network device is in conflict with control caused by a second control instruction packet on the network device. When the conflict judging module 803 judges that the control caused by the first control instruction packet on the network device is in conflict with the control caused by the second control instruction packet on the network device, the priority judging module 806 is configured to judge whether priority of the first control instruction packet is lower than priority of the second control instruction packet. When the authentication module 804 judges that the control caused by the first control instruction packet on the network device does not have the authorization or the priority judging module 806 judges that the priority of the first control instruction packet is lower than the priority of the second control instruction packet, the control module 807 is configured to prevent the first control instruction packet from being sent to the network device.

Optionally, the data storage unit 801 may be further configured to store an authorized service ID list. The authentication module 804 reads the authorized service ID list from the data storage unit 801 and judges whether a service corresponding to the first control instruction packet has authorization.

Optionally, the data storage unit 801 may be further configured to store a global control instruction list. The conflict judging module 803 reads the global control instruction list from the data storage unit 801 and judges whether the control caused by the first control instruction packet on the network device is in conflict with the control caused by the second control instruction packet on the network device.

Optionally, in the embodiment of the present invention, it is possible that the conflict judging module 803 is triggered after the authentication module 804 determines that the service corresponding to the first control instruction packet has the authorization; it is also possible that the authentication module 804 is triggered after the conflict judging module 803 determines that the control caused by the first control instruction packet on the network device is not in conflict with the control caused by the second control instruction packet on the network device; and it is also possible that the authentication module 804 is triggered after the priority judging module 806 judges that the priority of the first control instruction packet is not lower than the priority of the second control instruction packet.

Further optionally, the apparatus 800 may further include a forwarding module 805. The forwarding module 805 is configured to forward the first control instruction to the network device when the authentication conflict control module 802 judges that the control caused by the first control instruction packet on the network device meets the predefined rule.

For example, the conflict judging module 803 is triggered after the authentication module 804 determines that the service corresponding to the first control instruction packet has the authorization; if the judging result of the conflict judging module 803 is that the control caused by the first control instruction packet on the network device is in conflict with the control caused by the second control instruction packet on the network device, the priority judging module 806 compares the priority of the first control instruction packet with the priority of the second control instruction packet in further; and if the priority of the first control instruction packet is not lower than the priority of the second control instruction packet, the forward module 805 is triggered and the forward module 805 forwards the first control instruction packet to the network device.

Through the above descriptions of the embodiments, persons of ordinary skill in the art may clearly know that embodiments of the present invention may be realized by means of software and necessary general hardware platform; of course, the embodiments may also be realized through hardware. Based on such understanding, the technical solutions of embodiments of the present invention may be shown in the form of software products; the software products may be stored in a storage medium such as a ROM/RAM, a magnetic disk and an optical disk, and include a plurality of instructions for enabling a computer device, or a server, or other network devices to perform the methods described in each embodiment of the present invention or the methods described in certain parts of embodiments of the present invention.

The aboves are only preferable embodiments of the present invention, and are not used to limit the protection scope of the present invention. Any modification, equivalent replacement, improvement, and the like, made within the spirit and principle of the present invention shall be included in the protection scope of the present invention.

What is claimed is:

1. A method for controlling a network device, comprising:
intercepting, by an open service platform, a first control instruction packet sent to a network device;
judging, by the open service platform, whether control caused by the first control instruction packet on the network device meets a predefined rule; and
if the control does not meet the predefined rule, preventing, by the open service platform, the first control instruction packet from being sent to the network device.

2. The method according to claim 1, wherein the judging whether control caused by the first control instruction packet on the network device meets a predefined rule comprises:
judging whether the control caused by the first control instruction packet on the network device has authorization; and
determining that the control caused by the first control instruction packet on the network device does not meet the predefined rule when the control caused by the first control instruction packet on the network device does not have the authorization.

3. The method according to claim 2, wherein the judging whether the control caused by the first control instruction packet on the network device has authorization comprises:
acquiring a service identifier (ID) corresponding to the first control instruction packet; and
judging whether a service corresponding to the first control instruction packet has authorization by utilizing an authorized service ID list.

4. The method according to claim 3, wherein if the service corresponding to the first control instruction packet does not have the authorization, stopping sending the first control instruction packet to the network device.

5. The method according to claim 1, wherein the judging whether the control caused by the first control instruction packet on the network device meets a predefined rule comprises:
judging whether the control caused by the first control instruction packet on the network device is in conflict with control caused by a second control instruction packet on the network device; wherein the second control instruction packet is a control instruction packet intercepted by the open service platform prior to the first control instruction packet.

6. The method according to claim 5, wherein:
comparing priority of the first control instruction packet with priority of the second control instruction packet if the control caused by the first control instruction packet on the network device is in conflict with the control caused by the second control instruction packet on the network device; and
determining that the control caused by the first control instruction packet on the network device does not meet the predefined rule if the priority of the first control instruction packet is lower than the priority of the second control instruction packet.

7. An apparatus for controlling a network device, comprising an authentication conflict control module and a data storage unit; wherein
the data storage unit is configured to store an intercepted first control instruction packet sent to a network device and a predefined rule;
the authentication conflict control module is configured to read the first control instruction packet and the predefined rule from the data storage unit, and judge whether control caused by the first control instruction packet on the network device meets the predefined rule according to the predefined rule; and
the authentication conflict control module is configured to prevent the first control instruction packet from being sent to the network device if the control caused by the first control instruction packet on the network device does not meet the predefined rule.

8. The apparatus according to claim 7, wherein the authentication conflict control module further comprises an authentication module:
the authentication module is configured to judge whether the control caused by the first control instruction packet on the network device has authorization.

9. The apparatus according to claim 8, wherein the data storage unit is further configured to store an authorized service ID list;
the authentication module is configured to acquire a service identifier corresponding to the first control instruction packet; and
the authentication module is configured to read the authorized service ID list from the data storage unit, and utilize the authorized service ID list to judge whether a service corresponding to the first control instruction packet has authorization;
the authentication module is configured to stop sending the first control instruction packet to the network device if a judging result of the authentication module is that the service corresponding to the first control instruction packet does not have the authorization.

10. The apparatus according to claim 7, wherein the authentication conflict control module further comprises a conflict control module;
the conflict control module is configured to judge whether the control caused by the first control instruction packet on the network device is in conflict with control caused by a second control instruction packet on the network device; and
the second control instruction packet is a control instruction packet stored in the data storage unit and intercepted prior to the first control instruction packet.

11. The apparatus according to claim 10, wherein:
the conflict control module is configured to compare priority of the first control instruction packet with priority of the second control instruction packet if the control caused by the first control instruction packet on the network device is in conflict with the control caused by the second control instruction packet on the network device; and
the conflict control module is configured to determine that the control caused by the first control instruction packet on the network device does not meet the predefined rule if the priority of the first control instruction packet is lower than the priority of the second control instruction packet.
